(19) United States
(12) Patent Application Publication
(10) Pub. No.: US 2023/0419379 A1
(43) Pub. Date: Dec. 28, 2023

(54) DYNAMIC PEER-TO-PEER DIGITAL MARKETPLACE AND ICONIC TRANSFER FRAMEWORK

(71) Applicants: Ayman Momdouh Mohamed, Sterling, VA (US); Jeffrey Sweetbaum, London (GB); Cambria Whitcomb, Holland, MI (US)

(72) Inventors: Ayman Momdouh Mohamed, Sterling, VA (US); Jeffrey Sweetbaum, London (GB); Cambria Whitcomb, Holland, MI (US)

(21) Appl. No.: 17/847,394

(22) Filed: Jun. 23, 2022

(51) Int. Cl. G06Q 30/06

(52) U.S. Cl. CPC G06Q 30/0609

(57) ABSTRACT

A dynamic peer-to-peer digital marketplace and iconic transfer framework configured to provide individuals with digital tools that help shift emotional bonds from an object to a digital icon. The system may provide users options for retaining the digital record of the possessions in a digital collection. The system may be configured to allow users to divest physical possessions by using icon-related data to offer possessions up as a gift, in an exchange, in a show-and-tell manner, or for sale-to-donate. Subsequent possessors may receive the icon-related data on a device and subsequently add to icon-related data in order to dynamically update icons and collections.

### TECHNICAL FIELD

The embodiments generally relate to peer-to-peer digital marketplaces.

### BACKGROUND

Personal possessions may be charged with significant sentimental meaning preventing individuals from divesting said possessions. Consequently, individuals may hold onto things that are not needed or useful because of their emotional content, often at great expense and detriment to the possessor.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments disclosed herein provide for a dynamic peer-to-peer digital marketplace and iconic transfer framework configured to provide individuals with digital tools that help shift emotional bonds from a physical object to a digital surrogate of the possession i.e. an icon. The system may provide users options for disposing of physical possessions while retaining the digital record of the possessions in a digital collection. The system may be configured to allow users to divest physical possessions by using icon-related data to offer possessions up as a gift, in an exchange, in a show-and-tell manner, or for sale-to-donate. Subsequent possessors may receive the icon-related data on a device and subsequently add to icon-related data.

The disclosed dynamic peer-to-peer digital marketplace and iconic transfer framework facilitates dispossession of possessions with an easy-to-use divestment ritual called iconic transfer. With iconic transfer, users transfer the private meaning (memories, stories) from the object to be disposed to a non-physical digital icon that may include photos, videos, audio, or text stored in a digital collection. This dissolves a certain amount of emotional attachment to the original possession, making it easier for the user to pass that item on to another person. Thus, users are able to decrease the burden of storing and maintaining their physical possessions and the new possessor is able to acquire a needed item. Furthermore, this sort of resale transaction serves to decrease the number of new consumer goods called for, which helps mitigate the effects of climate change.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 depicts one illustrative variation of dynamic peer-to-peer digital marketplace and iconic transfer framework;

FIG. 2 depicts one illustrative variation of dynamic peer-to-peer digital marketplace and iconic transfer framework;

FIG. 3 depicts one illustrative variation of a use case of a dynamic peer-to-peer digital marketplace and iconic transfer framework;

FIG. 4 illustrates a graphical user interface of a dynamic peer-to-peer digital marketplace and iconic transfer framework;

FIG. 5 illustrates a graphical user interface of a dynamic peer-to-peer digital marketplace and iconic transfer framework; and

FIG. 6 illustrates a graphical user interface of a dynamic peer-to-peer digital marketplace and iconic transfer framework.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, apparatus, and/or computer program product at any possible technical detail level of integration. A computer program product can include, among other things, a computer-readable storage medium having computer-readable program instructions thereon for causing a processor to carry out aspects of the present disclosure.

As used herein, the term “user(s)” may refer to an individual or entity who directly interacts with a graphical user interface of the system disclosed herein. The term “user(s)” may also refer to an individual or entity indirectly interacting with the disclosed system.

As used herein, an “icon” and “iconization” and variations on those terms may refer to dynamic digital records making up a digital surrogate of a physical object and may include text, photo, video, and audio specifically associated with the physical object.

As used herein, “GUI” may refer to any graphical user interface that includes at least one interactive component between a user and the application. A GUI may include a plurality of fillable fields, clickable buttons, database displays, or the like. A GUI maybe adaptable for use on several devices such as computers, phones, smart devices, tablets, laptops, televisions, or the like.

In this disclosure, terms “store,” “storage,” “data store,” “data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

As used herein, “controller” may include a system including an electronic processor and configured to produce and/or execute control signals. Such a controller may be a distributed computing device such as a cloud computing system, or a localized computing system such as a field programmable gate array. The term “controller” as used herein may include a hybrid control system comprising, for example, edge computing devices configured to communicate with a remote computing system (e.g., a cloud computing system) and to share any described control tasks with the remote computing system.

In some embodiments, the methods described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to a processor such that the processor can read information from, and write information to, the storage medium. In the alternative, the storage medium may be integrated into the processor. Further, in some embodiments, the processor and the storage medium may reside in an Application Specific Integrated Circuit (ASIC). The processor and the storage medium may also reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, computer readable instructions executable by a controller and configured to carry out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The executable instructions can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the executable instructions can be downloaded to a computing/processing device from a computer readable storage medium, or to an external computer or external storage device via a network. A network adapter card or network interface in each computing/processing device receives computer readable program instructions from the network and forwards the computer readable executable instructions for storage in a computer readable storage medium within the respective computing/processing device.

Any connection between the components of the disclosed system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

The disclosed dynamic peer-to-peer digital marketplace and iconic transfer framework is a software utility that provides individuals the ability to record, display, and make shareable the stories of, and memories about, their possessions in text, photo, video, and audio formats. Individuals are able to compile these records in a digital archive or collection that is integrated into a peer-to-peer marketplace. The peer-to-peer marketplace offers users options for disposing of physical possessions while retaining the icon of the possessions in their collection. This record then appears in the collection of the acquiring user, complete with the associated descriptions and recorded information from the initial user, given the initial user's permission. Additionally, when an acquirer of a possession wants to divest it, they have the option to use this existing record, making it simple to post or share within the marketplace. Subsequent users can add to the history of an icon in their collection but can't delete any part of the record or icon details. According to some embodiments, icons and collection may be store in a database or data structure, such as a blockchain database.

Through the iconic transfer framework, users may use a collection utility to transfer private meaning from their physical possession to the icon. The icon will remain in the consumer's collection after any dispossession event. Users can choose to dispose of the object without the private meaning. Furthermore, users will also be able to share their icons and collections with others. The system may uniquely enable users to create an indelible record of their possessions and digitally store any private meaning they have. It also enables users to transfer that record along with the possession as it is downsized.

The framework consists of a user interface with prompts that walk users through the iconization process including a portal for uploading visual material, user interfaces that present private and public views of the user's icons, and an interface that allows users to edit their icons. This framework is built into the larger marketplace platform.

Users are able to record, save and share private meaning in digital formats that include text, voice, video, photos, or other attachments like PDFs. During the iconization process, users first upload visual and written material about their possession to the system. The user's icons, collectively form their collection, which also contains a component for the user's profile. Individual icons may remain in the collection in a published or unpublished state depending on the user's preference. Users may share their icons and collection with others via direct links to the webpages specific to those items or via social media platforms. Users can create multiple collections to feature different types of icons.

The iconization process is particularly novel within online marketplaces, which are generally remarkably transitory spaces. The ability to iconize possessions in the same environment through which users can dispossess their possessions is a decided benefit for the user over another method of iconization that they must manage in isolation. The combination of permanent iconization, social interaction, and a marketplace utility is not in existence elsewhere.

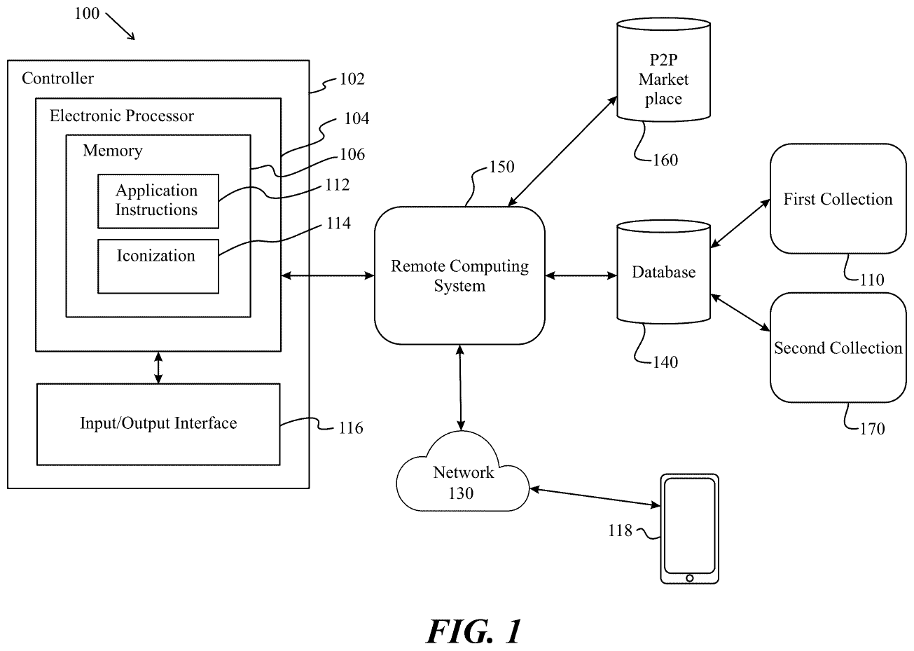

FIG. 1 depicts one illustrative variation of dynamic peer-to-peer digital marketplace and iconic transfer framework 100 including a controller 102 including an electronic processor 104 and an input/output interface 116. The input/output interface 116 is configured to receive data from a user via a user device 118 in operative communication with a remote computing system 150 in operative communication with a network 130. The memory 106 is configured to store application instructions 112 including an iconization framework 114 in operative in communication with a marketplace 160, and at least one collection such as a first collection 110 and second collection 170 stored in a database 140.

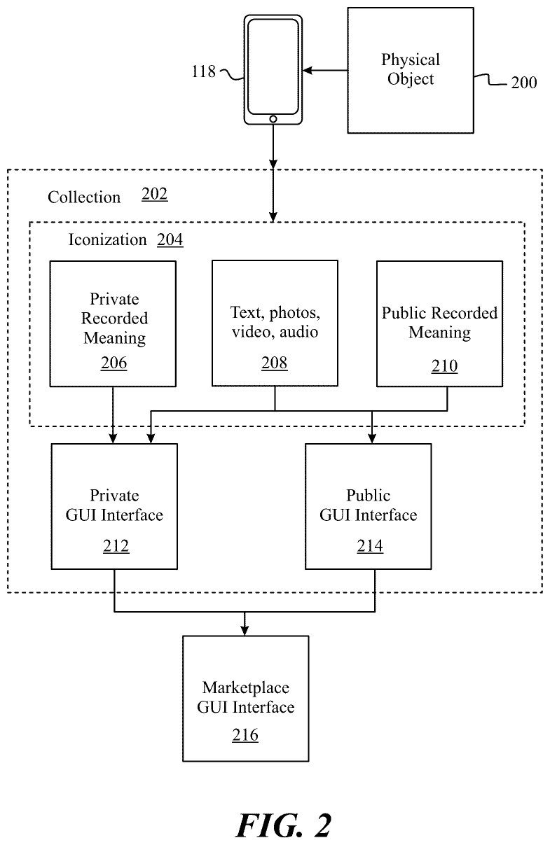

FIG. 2 depicts one illustrative variation of an iconization framework wherein a user may utilize a user device 118 to iconize at least one physical object 200. The iconization framework may receive a private recorded meaning or story 206 associated with the object; text, photos, video, or audio 208 associated with the object; or a public recorded meaning or story 210 and generate a private GUI interface 212 and a public GUI interface 214 correlating to the object 200. Iconization 204 may correlate private recorded meaning 206 and the private GUI interface 212 to a particular user or user registration and account from which the private recorded meaning 206 originated. Subsequent users may view or have access to the public GUI interface 214, and may submit additional private recorded meanings or stories 206 associated with the object; text, photos, video, or audio 208 associated with the object; or a public recorded meanings or stories 210 which may be assigned to the original iconization. Private recorded meanings 206 may be correlated to the user account from which the private recorded meaning 206 originated and may or may not be visible to subsequent user account associated with the icon 204 or collection 202. The collection 202 may include a plurality of icons 204.

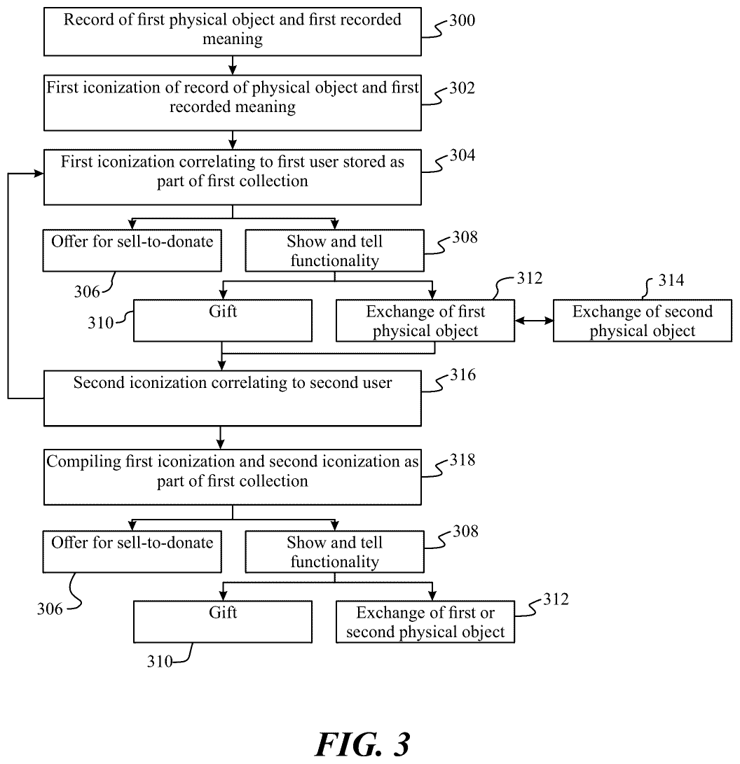

FIG. 3 depicts one illustrative variation of a use case of a dynamic peer-to-peer digital marketplace and iconic transfer framework in which the system may receive and record object data and a recorded meaning 300, such as a public recorded meaning and a private recorded meaning. The system may iconize 302 the record of object data and meanings. The system may store the iconization(s) within a collection 304 which may be publicly viewable dependent on user preference. The peer-to-peer marketplace may offer icons organized within a collection for sell-to-donate 306; as a gift 310; or as an exchange of the object 312 for a second object wherein the icons and collection include data from the first user and second user, and any subsequent users. Icons organized within a collection may also be stored in a show and tell display 308 where they function as social content and as digital records regardless of whether they are ever transacted through the peer-to-peer marketplace. The platform may offer collections or icons both privately, such as being publicly unpublished, but privately viewable and manageable, or publicly through the sell-to-donate 306; as a gift 310; exchange of the object 312; or via the show and tell 308 functionality. In this way, icons and collections may be privately or publicly viewed, managed, exchanged, sold, gifted, or the like. The platform may offer collections or icons across any of the sell-to-donate 306; gift 310; exchange 312; or show and tell 308 functions individually or simultaneously and a user may manage icons and collections within each function as desired.

According to some embodiments, a second user may be allowed access to an icon or collection within the system such that a second user may add a subsequent private recorded meaning or story associated with the object; text, photos, video, or audio associated with the object; or a public recorded meaning or story. The system may perform a second iconization 316 and compile the first iconization 304 and second iconization 318 and store the first iconization 304 and second iconization 318 as part of the same record. A peer-to-peer marketplace may publicly or privately offer collections or icons for sell-to-donate 306; show-and tell 308; as a gift 310; or an exchange of the object 312 for a second object 314 wherein icons and collection include data from the first user and second user, and subsequent users. In this way, icons and collections may be privately or publicly viewed, managed, exchanged, sold, gifted, or the like.

As a non-limiting example, a first user may upload or store item data such as photos, videos, and text relating to a set of toy blocks. The user may record a public meaning and private meaning associated with the first user's account registered with the system. The private meaning, public meaning, and item data may be iconized and stored in a database, such as in blockchain data structure. A second user may acquire the set of toy blocks, or may receive access to the iconization and may subsequently record a second public meaning, a second private meaning, or additional item data associated with the second user's account registered with the system. The private meaning, public meaning, and item data may be iconized with the second public meaning, second private meaning, or additional item data to update the stored icon in the database. Access to the icon may remain with the first user as well as the second user, while the first private meaning is accessible only by the first user, and the second private meaning is accessible only by the second user. Both the first user and second user may have access to the icon as part of at least one collection, or the icon may be stored as part of two separate collections accessible by the first and second user, respectively. Subsequent users may be permitted to record meanings associated with an icon such that the icon may include meanings associated with each user, some of which may be private meanings accessible only by the corresponding user.

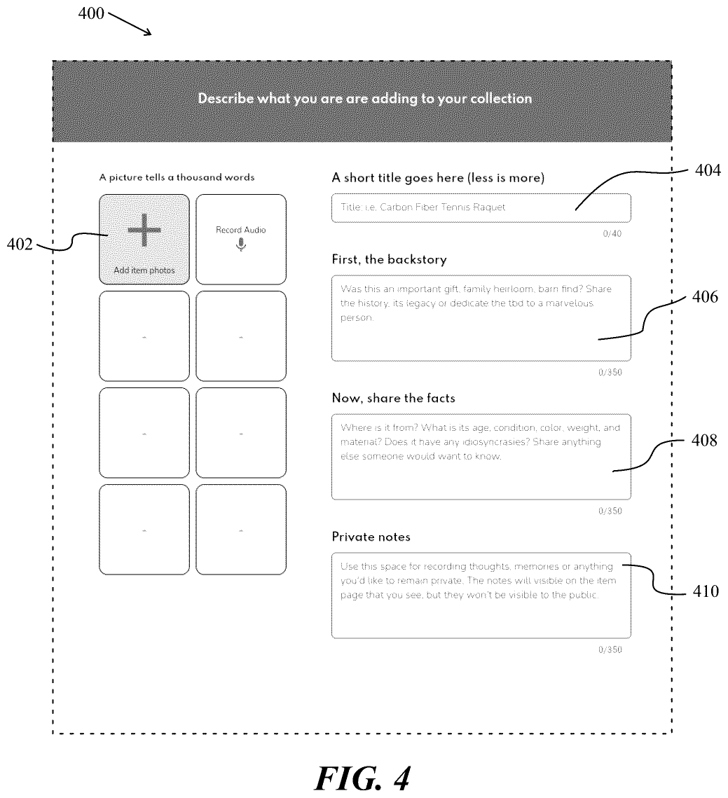

FIG. 4 depicts one illustrative variation of a GUI 400 for a dynamic peer-to-peer digital marketplace and iconic transfer framework which may allow user(s) to upload item data such as text, photos, video, or audio associated with the object. The GUI 400 may allow for input of item or object titles 404, public meanings such as backstory 406 or facts 408 about the item. Backstory 406 may include the nature of the object such as its significance as a past gift, family heirloom, barn discovery, item history, legacy, or the like. Facts 408 may include information such as item age, condition, materials, size, or the like. The GUI 400 may allow for input of item or object private meaning 410 which may be exclusively correlated to the user account associated with the inputting user.

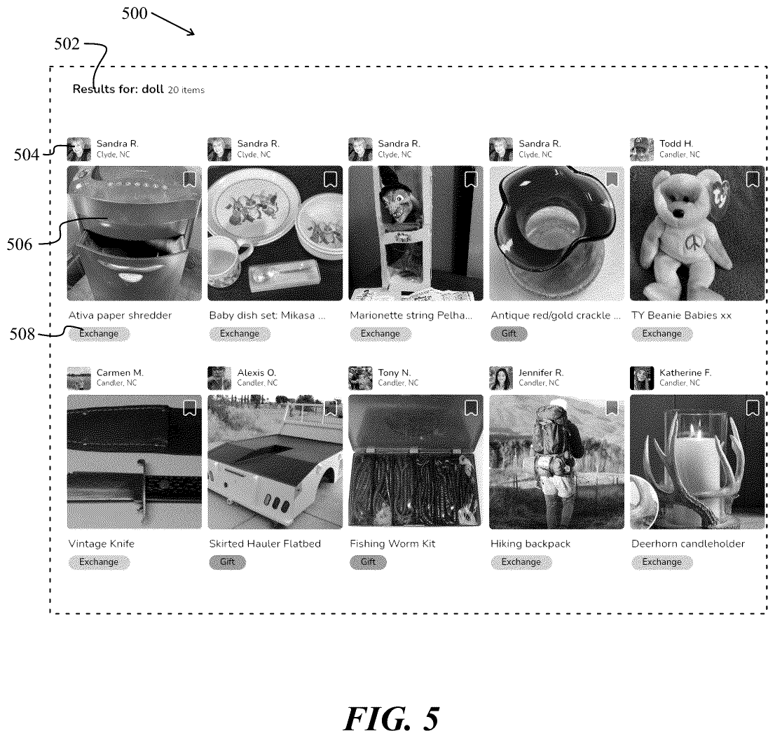

FIG. 5 depicts one illustrative variation of a GUI 500 for a dynamic peer-to-peer digital marketplace and iconic transfer framework which may allow user(s) to upload item data such as text, photos, video, or audio associated with the object. The GUI 500 may display various icons including the user account 504 currently associated with an icon; item data 506 associated with the icon; and marketplace functions 508 associated with the icon, such as public or private sell-to-donate; public or private show-and tell; a public or private gift; or a public or private exchange of the object and corresponding icon.

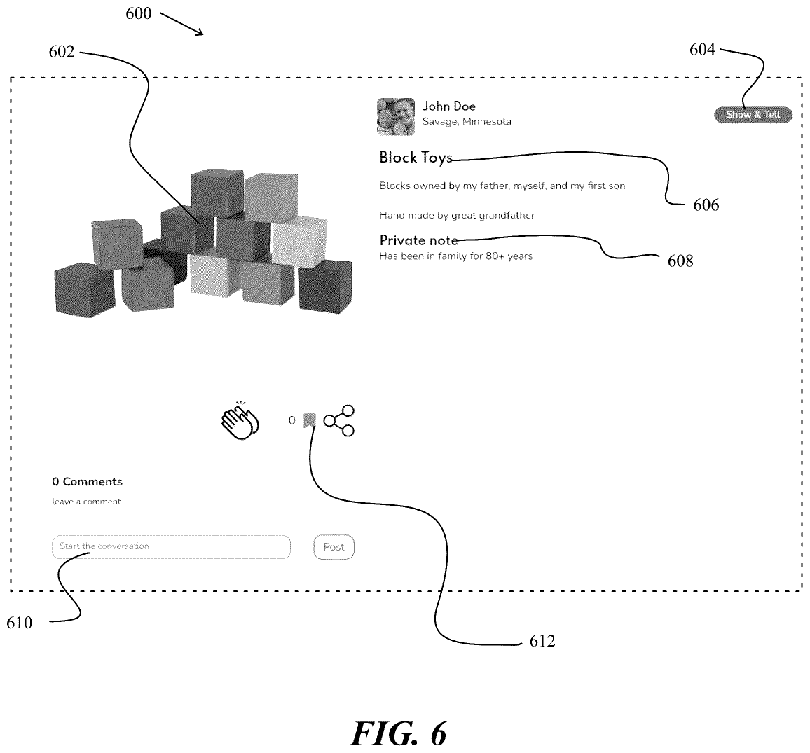

FIG. 6 depicts one illustrative variation of an icon within a GUI 600 within dynamic peer-to-peer digital marketplace and iconic transfer framework including item data 602, public description of meaning 606, and private meaning 608 viewable only by the user account that input the private meaning 608. The GUI 500 may provide means for public comments 610, digital support functionality 612, such as sharing, liking, and following, and marketplace functionality 604.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a method of using a dynamic peer-to-peer digital marketplace and iconic transfer framework may include receiving a first object data and a first recorded meaning associated with a first user account; recording the first object data and the first recorded meaning; iconizing the first object data and first recorded meaning to generate a first icon; associating the first icon with a first collection associated with the first user account; storing the first collection in a data structure; establishing permission to access the first icon and the first collection for the first user account; displaying at least one of the first collection or first icon in a peer-to-peer marketplace; establishing permission to access the first icon for a second user account; and associating the first icon with a second collection associated with the second user account.

Variation 2 may include a method as in variation 1, wherein the first recorded meaning includes a first public recorded meaning and a first private recorded meaning.

Variation 3 may include a method as in any of variations 1 through 2, wherein the first private recorded meaning is associated only with the first collection associated with the first user account.

Variation 4 may include a method as in any of variations 1 through 3, further including authorizing only the first user account to access the first private recorded meaning; and displaying the first private recorded meaning only to a first user device.

Variation 5 may include a method as in any of variations 1 through 4, further including receiving a second object data and a second recorded meaning associated with the second user account.

Variation 6 may include a method as in any of variations 1 through 5, further including iconizing the second object data and second recorded meaning to generate a second icon.

Variation 7 may include a method as in any of variations 1 through 6, further including associating the second icon with a second collection associated with the second user account.

Variation 8 may include a method as in any of variations 1 through 7, further including storing the second collection in the data structure.

Variation 9 may include a method as in any of variations 1 through 8, wherein the second recorded meaning includes a second public recorded meaning and a second private recorded meaning.

Variation 10 may include a method as in any of variations 1 through 9, wherein the second private recorded meaning is associated only with the second collection associated with the second user account.

Variation 11 may include a method as in any of variations 1 through 10, further including authorizing only the second user account to access the second private recorded meaning; and displaying the second private recorded meaning only to a second user device.

Variation 12 may include a method as in any of variations 1 through 11 wherein the first icon is associated with both the first collection and the second collection.

Variation 13 may include a method as in any of variations 1 through 12 wherein object data includes at least one of text data, imagery, a video, or recorded audio.

Variation 14 may include a method as in any of variations 1 through 13, wherein the data structure is a blockchain data structure.

According to variation 15, a non-transitory computer readable medium that, when executed by an electronic processor, is configured to perform a set of functions including receiving a first object data, a first public recorded meaning, and a first private recorded meaning associated with a first user account; iconizing the first object data, the first public recorded meaning, and the first private recorded meaning to generate a first icon; creating a first permission for only the first user account to access the first private recorded meaning; associating the first icon with a first collection associated with the first user account; storing the first collection in a data structure; displaying at least one of the first collection or first icon in a peer-to-peer marketplace; creating a second permission to access the first icon for a second user account; associating the first icon with a second collection associated with the second user account; receiving a second object data, a second public recorded meaning, and a second private recorded meaning associated with the second user account; iconizing the second object data, the second public recorded meaning, and the second private recorded meaning to generate a second icon; creating a third permission for only the second user account to access the second private recorded meaning; associating the second icon with a second collection associated with the second user account; and storing the second collection in the data structure.

Variation 16 may include a non-transitory computer readable medium as in variation 15, further including displaying the first private recorded meaning only to a first user device; and displaying the second private recorded meaning only to a second user device.

Variation 17 may include a non-transitory computer readable medium as in any of variations 15 through 16, wherein object data includes at least one of text data, imagery, a video, or recorded audio.

Variation 18 may include a non-transitory computer readable medium as in any of variations 15 through 17, wherein the data structure is a blockchain data structure.

Variation 19 may include a non-transitory computer readable medium as in any of variations 15 through 18, further including displaying at least one of the first icon or second icon in a peer-to-peer marketplace in operable communication with a network.

According to variation 20, a non-transitory computer readable medium that, when executed by an electronic processor, is configured to perform a set of functions including receiving a first object data, a first public recorded meaning, and a first private recorded meaning associated with a first user account; iconizing the first object data, the first public recorded meaning, and the first private recorded meaning to generate a first icon; creating a first permission for only the first user account to access the first private recorded meaning; associating the first icon with a first collection associated with the first user account; storing the first collection in a blockchain data structure; displaying at least one of the first collection or first icon in a peer-to-peer marketplace; creating a second permission to access the first icon for a second user account; associating the first icon with a second collection associated with the second user account; receiving a second object data, a second public recorded meaning, and a second private recorded meaning associated with the second user account; iconizing the second object data, the second public recorded meaning, and the second private recorded meaning to generate a second icon; creating a third permission for only the second user account to access the second private recorded meaning; associating the second icon with a second collection associated with the second user account; storing the second collection in the blockchain data structure; dynamically updating at least one of the first collection or second collection with subsequently generated icons; displaying the second collection including the first icon and the second icon on the second user device; displaying the second private recorded meaning only on the second user device; and displaying at least one of the first icon or second icon in a peer-to-peer marketplace in operable communication with a network.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the flowchart and block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

Many different embodiments have been disclosed herein, in connection with the above description and the drawings. It will be understood that it would be unduly repetitious and obfuscating to describe and illustrate every combination and sub combination of these embodiments. Accordingly, all embodiments can be combined in any way and/or combination, and the present specification, including the drawings, shall be construed to constitute a complete written description of all combinations and sub combinations of the embodiments described herein, and of the manner and process of making and using them, and shall support claims to any such combination or sub combination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a sub combination or variation of a sub combination.

It will be appreciated by persons skilled in the art that the present embodiment is not limited to what has been particularly shown and described hereinabove. A variety of modifications and variations are possible considering the above teachings without departing from the following claims.

What is claimed is:

1. A method of using a dynamic peer-to-peer digital marketplace and iconic transfer framework, the method comprising:
receiving a first object data and a first recorded meaning associated with a first user account;
recording the first object data and the first recorded meaning;
iconizing the first object data and first recorded meaning to generate a first icon;
associating the first icon with a first collection associated with the first user account;
storing the first collection in a data structure;
establishing permission to access the first icon and the first collection for the first user account;
displaying at least one of the first collection or first icon in a peer-to-peer marketplace;
establishing permission to access the first icon for a second user account; and
associating the first icon with a second collection associated with the second user account.

2. The method of claim 1, wherein the first recorded meaning comprises a first public recorded meaning and a first private recorded meaning.

3. The method of claim 2, wherein the first private recorded meaning is associated only with the first collection associated with the first user account.

4. The method of claim 3, further comprising:
authorizing only the first user account to access the first private recorded meaning; and
displaying the first private recorded meaning only to a first user device.

5. The method of claim 4, further comprising receiving a second object data and a second recorded meaning associated with the second user account.

6. The method of claim 5, further comprising:
iconizing the second object data and second recorded meaning to generate a second icon.

7. The method of claim 6, further comprising associating the second icon with a second collection associated with the second user account.

8. The method of claim 7, further comprising storing the second collection in the data structure.

9. The method of claim 8, wherein the second recorded meaning comprises a second public recorded meaning and a second private recorded meaning.

10. The method of claim 9, wherein the second private recorded meaning is associated only with the second collection associated with the second user account.

11. The method of claim 10, further comprising:
authorizing only the second user account to access the second private recorded meaning; and
displaying the second private recorded meaning only to a second user device.

12. The method of claim 1, wherein the first icon is associated with both the first collection and the second collection.

13. The method of claim 1, wherein object data comprises at least one of text data, imagery, a video, or recorded audio.

14. The method of claim 1, wherein the data structure is a blockchain data structure.

15. A non-transitory computer readable medium that, when executed by an electronic processor, is configured to perform a set of functions, the set of functions comprising:
receiving a first object data, a first public recorded meaning, and a first private recorded meaning associated with a first user account;
iconizing the first object data, the first public recorded meaning, and the first private recorded meaning to generate a first icon;
creating a first permission for only the first user account to access the first private recorded meaning;
associating the first icon with a first collection associated with the first user account;
storing the first collection in a data structure;
displaying at least one of the first collection or first icon in a peer-to-peer marketplace;
creating a second permission to access the first icon for a second user account;
associating the first icon with a second collection associated with the second user account;
receiving a second object data, a second public recorded meaning, and a second private recorded meaning associated with the second user account;
iconizing the second object data, the second public recorded meaning, and the second private recorded meaning to generate a second icon;
creating a third permission for only the second user account to access the second private recorded meaning;
associating the second icon with a second collection associated with the second user account; and
storing the second collection in the data structure.

16. The non-transitory computer readable medium of claim 15, further comprising:
displaying the first private recorded meaning only to a first user device; and
displaying the second private recorded meaning only to a second user device.

17. The non-transitory computer readable medium of claim 15, wherein object data comprises at least one of text data, imagery, a video, or recorded audio.

18. The non-transitory computer readable medium of claim 15, wherein the data structure is a blockchain data structure.

19. The non-transitory computer readable medium of claim 15, further comprising:
displaying at least one of the first icon or second icon in a peer-to-peer marketplace in operable communication with a network.

20. A non-transitory computer readable medium that, when executed by an electronic processor, is configured to perform a set of functions, the set of functions comprising:
receiving a first object data, a first public recorded meaning, and a first private recorded meaning associated with a first user account;
iconizing the first object data, the first public recorded meaning, and the first private recorded meaning to generate a first icon;
creating a first permission for only the first user account to access the first private recorded meaning;
associating the first icon with a first collection associated with the first user account;
storing the first collection in a blockchain data structure;
displaying at least one of the first collection or first icon in a peer-to-peer marketplace;
creating a second permission to access the first icon for a second user account;
associating the first icon with a second collection associated with the second user account;
receiving a second object data, a second public recorded meaning, and a second private recorded meaning associated with the second user account;
iconizing the second object data, the second public recorded meaning, and the second private recorded meaning to generate a second icon;
creating a third permission for only the second user account to access the second private recorded meaning;
associating the second icon with a second collection associated with the second user account;
storing the second collection in the blockchain data structure;
dynamically updating at least one of the first collection or second collection with subsequently generated icons;
displaying the second collection including the first icon and the second icon on the second user device;
displaying the second private recorded meaning only on the second user device; and
displaying at least one of the first icon or second icon in a peer-to-peer marketplace in operable communication with a network.
